(19) United States
(12) Patent Application Publication
(10) Pub. No.: US 2026/0117100 A1
(43) Pub. Date: Apr. 30, 2026

(54) ULTRAVIOLET TACKIFYING ADHESIVE TAPE AND PREPARATION METHOD THEREOF

(71) Applicant: BYE POLYMER MATERIAL CO., LTD, Kunshan (CN)

(72) Inventors: Sihai YU, Kunshan (CN); Jianyu TONG, Kunshan (CN)

(21) Appl. No.: 19/433,089

(22) Filed: Dec. 26, 2025

Related U.S. Application Data
(63) Continuation of application No. PCT/CN2025/118991, filed on Sep. 4, 2025.

(30) Foreign Application Priority Data
Jul. 29, 2024 (CN) 2024110199960

(51) Int. Cl. C09J 7/38; B32B 7/06; B32B 7/12; B32B 25/08; B32B 25/20; C09J 7/40

(52) U.S. Cl. CPC C09J 7/385; B32B 7/06; B32B 7/12; B32B 25/08; B32B 25/20; C09J 7/401; B32B 2250/02; B32B 2250/24; B32B 2307/7376; B32B 2307/748; B32B 2405/00; C09J 2301/414; C09J 2301/416; C09J 2483/005

(57) ABSTRACT

A UV tackifying adhesive tape and its preparation method are provided, and relate to the technical field of new adhesive tape materials. The UV tackifying adhesive tape includes a substrate layer, a UV tackifying adhesive layer, and a release film layer which are sequentially laminated together in a bottom-to-top order. The UV tackifying adhesive layer includes an acrylic-modified polyester resin, a monofunctional UV-curable monomer, a multifunctional photocurable compound, a curing agent, a photoinitiator, and a stabilizer. the UV tackifying adhesive layer employs the acrylic-modified polyester resin as the base polymer. The acrylic-modified polyester resin effectively improves the adhesion between the adhesive layer and the substrate before UV curing, enhances the bonding strength between the UV tackifying film and the adhered object after the UV curing, and increases the high-temperature peel strength and weather resistance of the UV tackifying film after the UV curing.

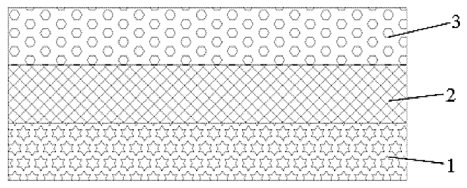

### TECHNICAL FIELD

The disclosure relates to the technical field of new adhesive tape materials, and more particularly to an ultraviolet (UV) tackifying adhesive tape and a preparation method thereof.

### BACKGROUND

For components such as display assemblies and cover glass in electronic devices like mobile phones and computers, it is necessary to laminate a layer of adhesive tape onto surfaces of the components to serve functions such as support, reinforcement, and acting as a shatterproof film. When the adhesive tape is applied to the surface of a material to be protected, it exhibits low initial tack, with a 180° peel strength ranging from 0.01-9 newtons per 25 millimeters (N/25 mm). The low initial tack allows for easy removal of the adhesive tape during rework or removement without damaging the surface of the adhered object, leaving no residual adhesive or contamination. After completing processes such as lamination and rework, it becomes necessary to increase the bonding strength between the adhesive tape and the adhered object to meet requirements for structural support and reliability against aging. Methods for increasing the bonding strength include heat-activated tack enhancement (thermal tackification) and UV-light-activated tackification (UV tackification). The thermal tackification works by heating to trigger chemical reactions in the adhesive layer of the adhesive tape, thereby increasing the bonding strength. However, due to the long reaction time and the temperature tolerance limitations of the adhered material, the thermal tackification is restricted in many applications. The UV tackification, on the other hand, utilizes light irradiation to initiate chemical reactions in the adhesive layer, enhancing the bonding strength between the adhesive tape and the surface of the protected material. The UV tackification has advantages in high reaction efficiency and the elimination of the need for high-temperature treatment.

Currently, a UV tackification solution disclosed in a patent by Nitto with publication No.: CN111876092A suffers from excessive UV crosslinking reactions, leading to significant volume shrinkage. This results in warping and deformation of the product during aging, which can affect adhesion of the product and the stability of subsequent processing parameters.

### SUMMARY

In response to the above shortcomings in the related art, the disclosure provides a UV tackifying adhesive tape and a preparation method thereof.

In order to achieve the above purposes, the disclosure uses the following technical solutions.

A UV tackifying adhesive includes a main resin, a photocurable composition, a curing agent, and a photoinitiator. The photocurable composition includes at least one of a monofunctional UV-curable monomer and a multifunctional photocurable compound. The main resin is an acrylic-modified polyester resin.

In an embodiment, the acrylic-modified polyester resin contains hydroxyl or carboxyl groups. The acrylic-modified polyester resin is synthesized by grafting a (meth)acrylate monomer onto a hydroxyl-terminated polyester resin.

In an embodiment, a synthetic method of the acrylic-modified polyester resin includes the following steps:
under nitrogen protection, adding, in parts by weight, 60-90 parts of the hydroxyl-terminated polyester resin, 100 parts of an organic solvent, 0.5-3 parts of methacryloyloxyethyl isocyanate (MOI) (also referred to as 2-isocyanatoethyl methacrylate), and 0.01-0.10 parts of dibutyltin dilaurate into a reactor, and raising a temperature to 50-70 degrees Celsius (° C.) to undergo a reaction for 4-6 hours (h); and
raising the temperature to 70-90° C., and slowly adding a mixture of 7-39.5 parts of the (meth)acrylate monomer and 0.1-2 parts of a free-radical polymerization initiator into the reactor to undergo a graft polymerization reaction for 3-5 h to obtain a solution of the acrylic-modified polyester resin.

In an embodiment, a synthetic method of the acrylic-modified polyester resin includes the following steps:
under nitrogen protection, adding, in parts by weight, 75 parts of the hydroxyl-terminated polyester resin, 100 parts of an organic solvent, 2.18 parts of MOI, and 0.075 parts of dibutyltin dilaurate into a reactor, and raising a temperature to 60° C. to undergo a reaction for 5 h; and
raising the temperature to 80° C., and slowly adding a mixture of 20 parts of the (meth)acrylate monomer and 1 parts of a free-radical polymerization initiator into the reactor to undergo a graft polymerization reaction for 4 h to obtain a solution of the acrylic-modified polyester resin.

In an embodiment, the organic solvent is formed by mixing one or more selected from the group consisting of ethyl acetate, toluene, acetone, butanone, and isopropanol in any proportion.

In an embodiment, the (meth)acrylate monomer includes one or more selected from the group consisting of methyl (meth)acrylate, ethyl (meth)acrylate, butyl (meth)acrylate, 2-ethylhexyl (meth)acrylate, octyl (meth)acrylate, lauryl (meth)acrylate, stearyl (meth)acrylate, and behenyl (meth)acrylate.

In an embodiment, the (meth)acrylate monomer includes one or more selected from the group consisting of ethyl (meth)acrylate, butyl (meth)acrylate, and 2-ethylhexyl (meth)acrylate. In an embodiment, the (meth)acrylate monomer is the butyl (meth)acrylate.

The (meth)acrylate herein refers to at least one of acrylate and methacrylate.

In an embodiment, the free-radical polymerization initiator is at least one of benzoyl peroxide and 2,2′-azobis(2-methylpropionitrile).

In an embodiment, the photocurable composition consists of the monofunctional UV-curable monomer and the multifunctional photocurable compound. A weight ratio of the monofunctional UV-curable monomer to the multifunctional photocurable compound is in a range of 1:2-5. In an embodiment, a weight ratio of the monofunctional UV-curable monomer to the multifunctional photocurable compound is 1:3.

The multifunctional photocurable compound is one selected from the group consisting of a multifunctional (meth)acrylate monomer, a multifunctional polyurethane (meth)acrylate oligomer, and a multifunctional polyester acrylate oligomer; and a functionality of the multifunctional photocurable compound is ≤3.

In an embodiment, the multifunctional (meth)acrylate monomer includes one or more selected from the group consisting of 1,4-butanediol diacrylate, 1,4-butanediol dimethacrylate, 1,6-hexanediol diacrylate, 1,6-hexanediol dimethacrylate, neopentyl glycol diacrylate, polyethylene glycol diacrylate, polypropylene glycol diacrylate, trimethylolpropane triacrylate, trimethylolpropane trimethacrylate, and glycerol triacrylate.

In an embodiment, the monofunctional UV-curable monomer includes one or more selected from the group consisting of 2-phenoxyethyl acrylate, ethoxy-ethoxy-ethyl acrylate, tetrahydrofurfuryl acrylate, lauryl acrylate, isodecyl acrylate, isononyl acrylate, and methoxypolyethylene glycol (350) methacrylate.

In an embodiment, the monofunctional UV-curable monomer includes one or more selected from the group consisting of the following monomers: 2-phenoxyethyl acrylate (PHEA, glass transition temperature (Tg): 7° C.), ethoxy-ethoxy-ethyl acrylate (EOEOEA, −56° C.), tetrahydrofurfuryl acrylate (THFA, −15° C.), lauryl acrylate (LA, −30° C.), isodecyl acrylate (ISODA, −58° C.), isononyl acrylate (INAA, −60° C.), and methoxypolyethylene glycol (350) methacrylate (−62° C.).

In an embodiment, the photoinitiator includes one or more selected from the group consisting of the following free radical photoinitiators: 1-hydroxycyclohexyl phenyl ketone, 2,4,6-trimethylbenzoyl diphenylphosphine oxide, ethyl (2,4,6-trimethylbenzoyl)phenylphosphinate, phenyl bis(2,4,6-trimethylbenzoyl) phosphine oxide, 2-benzyl-2-(dimethylamino)-4′-morpholino-butyroph, and 2-benzyl-2-dimethylamino-1-(4-piperidinylphenyl)-1-butanone.

In an embodiment, the UV tackifying adhesive further includes a stabilizer. The stabilizer is a phenolic compound or a quinonoid compound, and the stabilizer includes one or more selected from the group consisting of 4-methoxyphenol, 4-methoxy-1-naphthol, tert-butylhydroquinone, butylated hydroxytoluene, benzoquinone, and 1,4-naphthoquinone.

In an embodiment, the UV tackifying adhesive specifically includes: in parts by weight, 30-50 parts of the acrylic-modified polyester resin, 5-30 parts of the monofunctional UV-curable monomer, 5-30 parts of the multifunctional photocurable compound, 0.2-1.5 parts of the curing agent, 0.5-2 parts of the photoinitiator, and 0.01-0.1 parts of the stabilizer.

In an embodiment, the UV tackifying adhesive specifically includes: in parts by weight, 35 parts of the acrylic-modified polyester resin, 5 parts of the monofunctional UV-curable monomer, 15 parts of the multifunctional photocurable compound, 0.75 parts of the curing agent, 1.5 parts of the photoinitiator, and 0.05 parts of the stabilizer.

In an embodiment, the curing agent is a polyisocyanate curing agent or a carboxyl cross-linking agent capable of reacting with hydroxyl or carboxyl groups.

The polyisocyanate curing agent is a compound containing two or more isocyanate groups per molecule, and is one of aromatic polyisocyanate and aliphatic polyisocyanate.

The carboxyl cross-linking agent is at least one of multifunctional aziridine (trimethylolpropane tris [3-(2-methylaziridin) propionate], SC-100) and a tetrafunctional epoxy resin (N,N,N′,N′-tetraglycidyl-meta-xylene diamine, GA-240).

A UV tackifying adhesive tape includes a substrate layer, a UV tackifying adhesive layer, and a release film layer. The UV tackifying adhesive layer is prepared by coating the UV tackifying adhesive onto a surface of the substrate layer. The release film layer is laminated to a side of the UV tackifying adhesive layer facing away from the substrate layer.

A thickness of the release film layer is in a range of 25-100 micrometers (μm), and the release film layer is a silicone release film or a non-silicone release film. In an embodiment, the release film layer is polyethylene terephthalate (PET).

A thickness of the UV tackifying adhesive layer is in a range of 5-100 μm.

The substrate layer is one selected from the group consisting of PET, polyolefin (PO), polypropylene (PP), polyethylene (PE), polyimide (PI), and polyethylene naphthalate (PEN), and a thickness of the substrate layer is in a range of 5-300 μm. In an embodiment, the substrate layer is PET.

The substrate layer is one selected from the group consisting of PET, a polyolefin film (PO/PP/PE), PI, and PEN, and a thickness of the substrate layer is in a range of 5-300 μm.

A preparation method of a UV tackifying adhesive tape includes the following steps:
(1) adding an acrylic-modified polyester resin, a monofunctional UV-curable monomer and a multifunctional photocurable compound to a second organic solvent followed by stirring uniformly to obtain a mixed solution, adding a curing agent, a photoinitiator and a stabilizer each to a third organic solvent to obtain solutions, and adding the solutions to the mixed solution followed by stirring uniformly to obtain a UV tackifying adhesive; and
(2) coating the UV tackifying adhesive obtained in step (1) onto a surface of a substrate and heating at 50-130° C. for 3-5 minutes (min) for drying and curing to obtain a dried layer, and laminating a release film onto the dried layer followed by aging at 40-50° C. for 48-72 h to obtain the UV tackifying adhesive tape.

In step (1), each of the second organic solvent and the third organic solvent is formed by mixing one or more selected from the group consisting of ethyl acetate, toluene, acetone, butanone, and isopropanol in any proportion.

The technical solutions provided by the disclosure have the following beneficial effects.

(1) Since the polyester resin and the PET substrate are both polyester materials, the prepared UV tackifying adhesive layer exhibits high cohesive strength and good adhesion to the PET substrate. The UV tackifying adhesive layer obtained from the acrylic-modified polyester resin exhibits no significant increase in initial peel strength over time before the UV tackification reaction, thereby allowing easy removal without causing damage or residual adhesive contamination to the adhered object.

(2) After the UV tackification reaction, the modified polyester resin enhances the bonding strength between the tape and the adhered object, with no adverse effects such as layer separation, bubbling, or haze increase in the adhesive layer.

(3) In the UV tackifying film of the disclosure and its preparation method, the UV tackifying adhesive layer employs the acrylic-modified polyester resin as the base polymer. The acrylic-modified polyester resin effectively improves the adhesion between the adhesive layer and the substrate before UV curing, enhances the bonding strength between the UV tackifying film and the adhered object after the UV curing, and increases the high-temperature peel strength and weather resistance of the UV tackifying film after the UV curing.

### BRIEF DESCRIPTION OF DRAWING

In order to provide a clearer explanation of technical solutions in the embodiments of the disclosure or in the related art, a brief introduction will be given to the accompanying drawing required for the description of the embodiments or the related art. It is apparent that the drawing described below is only some embodiments of the disclosure. For those skilled in the art, other drawings can be obtained based on the drawing without creative labor.

FIGURE illustrates a schematic structural diagram of a UV tackifying adhesive tape of the disclosure.

### DESCRIPTION OF REFERENCE SIGNS

1: substrate layer; 2: UV tackifying adhesive layer; 3: release film layer.

### DETAILED DESCRIPTION OF EMBODIMENTS

In order to clarify the purpose, technical solution, and advantages of the embodiments of the disclosure, a clear and complete description of the technical solutions in the embodiments of the disclosure will be provided below in conjunction with the accompanying drawing. Apparently, the described embodiments are a part of the embodiments of the disclosure, not all embodiments. Based on the embodiments of the disclosure, all other embodiments obtained by those skilled in the art without creative labor are within the scope of protection of the disclosure.

The disclosure will be further described in conjunction with the embodiments. 1. The preparation of a UV tackifying adhesive tape is as follows.

### Embodiment 1

A preparation method of a UV tackifying adhesive tape includes the following steps (1)-(2).

(1) 35 parts of an acrylic-modified polyester resin, 5 parts of a monofunctional UV-curable monomer, and 15 parts of a multifunctional UV-curable compound (i.e., a multifunctional photocurable compound) are added to 100 parts of ethyl acetate followed by stirring uniformly to obtain a mixed solution; 0.75 parts of a curing agent, 1.5 parts of a photoinitiator and 0.05 parts of a stabilizer each is dissolved in 10 parts of ethyl acetate to obtain solutions; and the solutions are added to the mixed solution followed by stirring uniformly to obtain a UV tackifying adhesive.

(2) The UV tackifying adhesive is coated onto a transparent PET film with a thickness of 75 μm at a coating weight of 52 grams per square meter (g/m²), followed by drying at 110° C. for 3 min to obtain a dried layer; and a transparent PET release film with a thickness of 50 μm is laminated onto the dried layer followed by curing at 40° C. for 48 h to obtain the UV tackifying adhesive tape. A thickness of a UV tackifying adhesive layer 2 is 13 μm.

A preparation method of the acrylic-modified polyester resin includes the following steps.

Under nitrogen protection, in parts by weight, 75 parts of a hydroxyl-terminated polyester resin, 100 parts of ethyl acetate, 2.18 parts of MOI, and 0.075 parts of dibutyltin dilaurate catalyst are added into a reactor, and a temperature is raised to 60° C. to undergo a reaction for 5 h; and then the temperature is raised to 80° C., and a mixture of 20 parts of butyl methacrylate and 1 parts of a free-radical polymerization initiator (benzoyl peroxide and azobisisobutyronitrile, with a weight ratio of 2:1) is slowly added into the reactor to undergo a graft polymerization reaction for 4 h to obtain an acrylic-modified polyester resin solution.

The hydroxyl-terminated polyester resin is GK680 of Toyobo Co., Ltd., Japan with a hydroxyl value of 21 milligrams of potassium hydroxide per gram (mg KOH/g). The MOI (MOI monomer, methacryloyloxyethyl isocyanate, Showa Denko, Japan) is sourced from Shanghai Macklin Biochemical Co., Ltd.

The monofunctional UV-curable monomer is 2-phenoxyethyl acrylate (PHEA, Tg: 7° C.). The multifunctional photocurable compound is polyethylene glycol (400) diacrylate.

The curing agent is polyisocyanate curing agent (DesmodurR L 75, the NCO content=13.3%).

The photoinitiator is 1-hydroxycyclohexyl phenyl ketone.

The stabilizer is 4-methoxyphenol.

### Embodiment 2

This embodiment differs from the embodiment 1 only in that the monofunctional UV-curable monomer is 2 parts by weight, and the multifunctional UV-curable compound is 10 parts by weight.

### Embodiment 3

This embodiment differs from the embodiment 1 only in that the multifunctional UV-curable compound is polyethylene glycol (200) diacrylate.

### Comparative Embodiment 1

This comparative embodiment differs from the embodiment 1 only in that a polyacrylate random copolymer (Tg=−35° C., weight-average molecular weight (Mw)=800000, hydroxyl value=13 mg KOH/g, acid value=28 mg KOH/g) is used to replace the acrylic-modified polyester resin.

### Comparative Embodiment 2

This comparative embodiment differs from the embodiment 1 only in that a polyacrylate triblock copolymer (polymethyl methacrylate-b-poly (n-butyl acrylate)-b-polymethyl methacrylate, PMMA-b-PnBA-b-PMMA, Mw=1000000, molecular weight distribution polydispersity index (PDI)=1.3) is used to replace the acrylic-modified polyester resin.

### Comparative Embodiment 3

This comparative embodiment differs from the embodiment 1 only in that polyethylene glycol (400) diacrylate is replaced with dipentaerythritol hexaacrylate.

### Comparative Embodiment 4

This comparative embodiment differs from the embodiment 1 only in that the monofunctional UV-curable monomer is not added.

### Comparative Embodiment 5

This comparative embodiment differs from the embodiment 1 only in that the multifunctional UV-curable compound is not added.

2. Performance testing is as follows.

The UV tackifying adhesive tapes prepared in the above embodiments and comparative embodiments are respectively subjected to tests including peel strength before and after UV irradiation, reliability aging performance under different conditions, and aging shrinkage rate. The test methods are as follows.

(1) Initial 180° peel strength test: samples from the embodiments and comparative embodiments are cut into strips each with a width of 25 mm and a length of 250 mm. The release film is removed and each sample strip is laminated onto a 75 μm×50 mm×150 mm PI film. The end of each strip is clamped in the tensile grip of a tensile testing machine, and 180° peeling is performed at a speed of 300 mm/min. Five sets of data are tested and the average value is calculated.

(2) UV-tackified 180° peel strength test: samples from the embodiments and comparative embodiments are cut into strips each with a width of 25 mm and a length of 250 mm. The release film is removed and each sample strip is laminated onto a 75 μm×50 mm×150 mm PI film. Each sample strip is irradiated using a 365 nanometer (nm) light emitting diode (LED) light source with an exposure energy of 4000 millijoules per square centimeter (mJ/cm²) (intensity of 200 milliwatts per square centimeter (mW/cm²) for 20 seconds). The end of each strip is clamped in the tensile grip of a tensile testing machine, and 180° peeling is performed at a speed of 300 mm/min. Five sets of data are tested and the average value is calculated.

(3) Substrate adhesion test: per Japanese industrial standard (JIS) K 5600, a grid of 10× 10 squares spaced 1 mm apart is scribed through the adhesive layer of each UV-tackifying adhesive tape sample. A transparent adhesive tape (3M™ Scotch®) is applied and then rapidly peeled off at 90°. The number of squares remaining intact is recorded and rated as follows:
∘: 100/100; Δ: 99/100-80/100; x: 0/100-79/100.

(4) Dual-85 aging test: samples from the embodiments and comparative embodiments are cut into strips each with a width of 50 mm and a length of 150 mm. The release film is removed and each sample strip is laminated onto a 75 μm×100 mm×200 mm PI film. Each sample strip is irradiated with a 365 nm LED light source at 4000 mJ/cm² (intensity of 200 mW/cm² for 20 seconds). Each sample strip is placed in a constant temperature and humidity chamber at 85° C. and 85% relative humidity for aging for 240 h. It is examined that whether defects such as bubbling, delamination, or cracking occur between each sample and the PI film. The sample is rated “qualified” if none of the above defects are observed; otherwise, it is rated “unqualified”.

(5) 60° C.-90% aging test: samples from the embodiments and comparative embodiments are cut into strips each with a width of 50 mm and a length of 150 mm. The release film is removed and each sample strip is laminated onto a 75 μm×100 mm×200 mm PI film. Each sample strip is irradiated with a 365 nm LED light source at 4000 mJ/cm² (intensity of 200 mW/cm² for 20 seconds). Each sample strip is placed in a constant temperature and humidity chamber at 60° C. and 90% relative humidity for aging for 240 h. It is examined that whether defects such as bubbling, delamination, or cracking occur between each sample and the PI film. The sample is rated “qualified” if none of the above defects are observed; otherwise, it is rated “unqualified”.

(6)−40° C. aging test: samples from the embodiments and comparative embodiments are cut into strips each with a width of 50 mm and a length of 150 mm. The release film is removed and each sample strip is laminated onto a 75 μm×100 mm×200 mm PI film. Each sample is irradiated with a 365 nm LED light source at 4000 mJ/cm² (intensity of 200 mW/cm² for 20 seconds). Each sample strip is placed in a constant temperature and humidity chamber at −40° C. for aging for 240 h. It is examined that whether defects such as bubbling, delamination, or cracking occur between each sample and the PI film. The sample is rated “qualified” if none of the above defects are observed; otherwise, it is rated “unqualified”.

(7) Thermal shock aging test: samples from the embodiments and comparative embodiments are cut into strips each with a width of 50 mm and a length of 150 mm. The release film is removed and each sample strip is laminated onto a 75 μm×100 mm×200 mm PI film. Each sample strip is irradiated with a 365 nm LED light source at 4000 mJ/cm² (intensity of 200 mW/cm² for 20 seconds). Each sample is placed in a thermal shock chamber cycling between −40° C. and 85° C. with a 30-minute cycle time for 100 cycles. It is examined that whether defects such as bubbling, delamination, or cracking occur between each sample and the PI film. The sample is rated “qualified” if none of the above defects are observed; otherwise, it is rated “unqualified”.

(8) Aging shrinkage rate test: samples from the embodiments and comparative embodiments are cut to A4 paper size. The release film is removed and each sample is laminated onto a 250 mm×330 mm glass plate. Each sample is irradiated with a 365 nm LED light source at 4000 mJ/cm² (intensity of 200 mW/cm² for 20 seconds). Four edge lengths of each sample are measured using a high-precision two-dimensional measuring microscope. Each sample is placed in a constant temperature and humidity chamber at 85° C. and 85% relative humidity for aging for 240 h, and then is removed and cooled to room temperature. The four edge lengths of each cooled sample are measured using the above microscope. The aging shrinkage rate is calculated using the following formula:

$${machine direction ( MD ) shrinkage rate = ( 1 - L ’}_{MD} ) / {L}_{MD}$$

$${transverse direction ( TD ) shrinkage rate = ( 1 - L ’}_{TD} ) / {L}_{TD}$$

where L′_{MD} represents a size of the sample in the MD after aging at 85° C. and 85% relative humidity for 240 h; L_{MD} represents a size of the sample in the MD before aging at 85° C. and 85% relative humidity for 240 h; L′_{TD} represents a size of the sample in the TD after aging at 85° C. and 85% relative humidity for 240 h; and LTD represents a size of the sample in the TD before aging at 85° C. and 85% relative humidity for 240 h.

Specific test results are shown in the following table:

| | | | | Comparative | Comparative | Comparative | Comparative | Comparative |
|---|---|---|---|---|---|---|---|---|
| | Embodiment | Embodiment | Embodiment | embodiment | embodiment | embodiment | embodiment | embodiment |
| Test item | 1 | 2 | 3 | 1 | 2 | 3 | 4 | 5 |
| Initial | 13 | 30 | 8 | 125 | 50 | 28 | 42 | 24 |
| 180° peel | | | | | | | | |
| strength | | | | | | | | |
| (PI, g/25 | | | | | | | | |
| mm) | | | | | | | | |
| UV- | 1890 | 1547 | 1320 | 570 | 2200 | 120 | 2270 | 101 |
| tackified | | | | | | | | |
| 180° peel | | | | | | | | |
| strength | | | | | | | | |
| (PI, g/25 | | | | | | | | |
| mm) | | | | | | | | |
| Substrate | ∘ | ∘ | ∘ | ∘ | x | x | ∘ | x |
| adhesion | | | | | | | | |
| Dual-85 | Qualified | Qualified | Qualified | Unqualified | Qualified | Unqualified | Qualified | Unqualified |
| aging for | | | | | | | | |
| 240 h | | | | | | | | |
| 60° C.&90% | Qualified | Qualified | Qualified | Unqualified | Unqualified | Unqualified | Qualified | Unqualified |
| aging | | | | | | | | |
| for 240 h | | | | | | | | |
| −40° C. | Qualified | Qualified | Qualified | Unqualified | Unqualified | Unqualified | Qualified | Unqualified |
| aging for | | | | | | | | |
| 240 h | | | | | | | | |
| Thermal | Qualified | Unqualified | Qualified | Unqualified | Unqualified | Unqualified | Qualified | Unqualified |
| shock | | | | | | | | |
| aging for | | | | | | | | |
| 100 | | | | | | | | |
| cycles | | | | | | | | |
| Aging | 0.015 | 0.009 | 0.071 | 0.017 | 0.482 | 0.021 | 0.071 | 0.015 |
| shrinkage | | | | | | | | |
| rate in | | | | | | | | |
| MD (%) | | | | | | | | |
| Aging | 0.021 | 0.019 | 0.049 | 0.016 | 0.318 | 0.017 | 0.097 | 0.014 |
| shrinkage | | | | | | | | |
| rate in TD | | | | | | | | |
| (%) | | | | | | | | |

The UV tackifying adhesive tape of the disclosure uses the modified polyester resin in the UV tackifying adhesive layer 2, which reduces volume shrinkage and stress during the photocuring process, thereby avoiding warping or deformation caused by stress induced by photocuring-induced volume shrinkage during application. At the same time, the peel strength after UV tackification can be enhanced, with the UV-tackified 180° peel strength exceeding 1200 g/25 mm. In addition, the UV tackifying adhesive of the disclosure employs the modified polyester resin, and thus the product is fold-resistant and exhibits high creep recovery.

Since the modified polyester resin and the PET substrate are both polyester materials, the prepared UV tackifying adhesive layer 2 exhibits high cohesive strength and good adhesion to the PET substrate. The UV adhesive layer 2 obtained from the acrylic-modified polyester resin shows no significant increase in initial peel strength over time before the UV tackification reaction, thus allowing easy removal without causing damage or residual adhesive contamination to the adhered object. After the UV tackification reaction, the modified polyester resin can enhance the bonding strength between the tape and the adhered object.

In the UV tackifying adhesive film of the disclosure and its preparation method, the UV tackifying adhesive layer 2 employs the acrylic-modified polyester resin as the base polymer. The acrylic-modified polyester resin effectively improves the adhesion between the adhesive layer and the substrate before UV curing, enhances the bonding strength between the UV-tackifying film and the adhered object after the UV curing, and increases the high-temperature peel strength and weather resistance of the UV tackifying film after the UV curing.

The above embodiments are only used to illustrate the technical solutions of the disclosure and not to limit it. Although the disclosure has been described in detail with reference to the aforementioned embodiments, those skilled in the art should understand that they can still modify the technical solutions described in the aforementioned embodiments, or equivalently replace some of the technical features. These modifications or substitutions will not make the essence of the corresponding technical solutions deviate from the scope of protection of the technical solutions of the embodiments of the disclosure.

What is claimed is:

1. An ultraviolet (UV) tackifying adhesive, comprising:
a main resin, being an acrylic-modified polyester resin, wherein the acrylic-modified polyester resin is synthesized by grafting a (meth)acrylate monomer onto a hydroxyl-terminated polyester resin;
a photocurable composition, comprising: a monofunctional UV-curable monomer and a multifunctional photocurable compound;
a curing agent; and
a photoinitiator.

2. The UV tackifying adhesive as claimed in claim 1, wherein the acrylic-modified polyester resin is synthesized through the following steps:
under nitrogen protection, adding, in parts by weight, 60-90 parts of the hydroxyl-terminated polyester resin, 100 parts of an organic solvent, 0.5-3 parts of methacryloyloxyethyl isocyanate (MOI), and 0.01-0.10 parts of dibutyltin dilaurate into a reactor, and raising a temperature to 50-70 degrees Celsius (C) to undergo a reaction for 4-6 hours (h); and
raising the temperature to 70-90° C., and adding a mixture of 7-39.5 parts of the (meth)acrylate monomer and 0.1-2 parts of a free-radical polymerization initiator into the reactor to undergo a graft polymerization reaction for 3-5 h to obtain a solution of the acrylic-modified polyester resin.

3. The UV tackifying adhesive as claimed in claim 1, wherein a weight ratio of the monofunctional UV-curable monomer to the multifunctional photocurable compound is in a range of 1:2-5;
wherein the multifunctional photocurable compound is one selected from the group consisting of a multifunctional (meth)acrylate monomer, a multifunctional polyurethane (meth)acrylate oligomer, and a multifunctional polyester acrylate oligomer; and a functionality of the multifunctional photocurable compound is ≤3; and
wherein the multifunctional (meth)acrylate monomer comprises one or more selected from the group consisting of 1,4-butanediol diacrylate, 1,4-butanediol dimethacrylate, 1,6-hexanediol diacrylate, 1,6-hexanediol dimethacrylate, neopentyl glycol diacrylate, polyethylene glycol diacrylate, polypropylene glycol diacrylate, trimethylolpropane triacrylate, trimethylolpropane trimethacrylate, and glycerol triacrylate.

4. The UV tackifying adhesive as claimed in claim 1, wherein the monofunctional UV-curable monomer comprises one or more selected from the group consisting of 2-phenoxyethyl acrylate, ethoxy-ethoxy-ethyl acrylate, tetrahydrofurfuryl acrylate, lauryl acrylate, isodecyl acrylate, isononyl acrylate, and methoxypolyethylene glycol (350) methacrylate.

5. The UV tackifying adhesive as claimed in claim 1, wherein the photoinitiator comprises one or more selected from the group consisting of the following free radical photoinitiators: 1-hydroxycyclohexyl phenyl ketone, 2,4,6-trimethylbenzoyl diphenylphosphine oxide, ethyl (2,4,6-trimethylbenzoyl)phenylphosphinate, phenyl bis(2,4,6-trimethylbenzoyl) phosphine oxide, 2-benzyl-2-(dimethylamino)-4′-morpholino-butyroph, and 2-benzyl-2-dimethylamino-1-(4-piperidinylphenyl)-1-butanone.

6. The UV tackifying adhesive as claimed in claim 1, further comprising: a stabilizer, wherein the stabilizer is a phenolic compound or a quinonoid compound, and the stabilizer comprises one or more selected from the group consisting of 4-methoxyphenol, 4-methoxy-1-naphthol, tert-butylhydroquinone, butylated hydroxytoluene, benzoquinone, and 1,4-naphthoquinone.

7. The UV tackifying adhesive as claimed in claim 6, specifically comprising: in parts by weight, 30-50 parts of the acrylic-modified polyester resin, 5-30 parts of the monofunctional UV-curable monomer, 5-30 parts of the multifunctional photocurable compound, 0.2-1.5 parts of the curing agent, 0.5-2 parts of the photoinitiator, and 0.01-0.1 parts of the stabilizer.

8. The UV tackifying adhesive as claimed in claim 1, wherein the curing agent is a polyisocyanate curing agent or a carboxyl cross-linking agent capable of reacting with hydroxyl or carboxyl groups;
wherein the polyisocyanate curing agent is a compound containing two or more isocyanate groups per molecule, and is one of aromatic polyisocyanate and aliphatic polyisocyanate; and
wherein the carboxyl cross-linking agent is at least one of multifunctional aziridine and a tetrafunctional epoxy resin.

9. A UV tackifying adhesive tape, comprising:
a substrate layer,
a UV tackifying adhesive layer, prepared by coating the UV tackifying adhesive as claimed in claim 1 onto a surface of the substrate layer; and
a release film layer, laminated to a side of the UV tackifying adhesive layer facing away from the substrate layer;
wherein a thickness of the release film layer is in a range of 25-100 micrometers (μm), and the release film layer is a silicone release film or a non-silicone release film; a thickness of the UV tackifying adhesive layer is in a range of 5-100 μm; and the substrate layer is one selected from the group consisting of polyethylene terephthalate (PET), polyolefin (PO), polypropylene (PP), polyethylene (PE), polyimide (PI), and polyethylene naphthalate (PEN), and a thickness of the substrate layer is in a range of 5-300 μm.

10. A preparation method of a UV tackifying adhesive tape, comprising the following steps:
(1) adding an acrylic-modified polyester resin and a photocurable composition to a second organic solvent followed by stirring uniformly to obtain a mixed solution, adding a curing agent, a photoinitiator and a stabilizer each to a third organic solvent to obtain solutions, and adding the solutions to the mixed solution followed by stirring uniformly to obtain a UV tackifying adhesive; and
(2) coating the UV tackifying adhesive obtained in step (1) onto a surface of a substrate and heating at 50-130° C. for 3-5 minutes for drying and curing to obtain a dried layer, and laminating a release film onto the dried layer followed by aging at 40-50° C. for 48-72 h to obtain the UV tackifying adhesive tape;
wherein in step (1), each of the second organic solvent and the third organic solvent is formed by mixing one or more selected from the group consisting of ethyl acetate, toluene, acetone, butanone, and isopropanol in any proportion.
